(19) United States
(12) Patent Application Publication
(10) Pub. No.: US 2011/0223306 A1
(43) Pub. Date: Sep. 15, 2011

(54) FOOD PREPARATION DEVICE

(76) Inventors: Neil Andrew Allen, Bicton (AU); Edward Joseph Khoury, Bateman (AT)

(21) Appl. No.: 13/059,544

(22) PCT Filed: Aug. 12, 2009
(86) PCT No.: PCT/AU09/01038

§ 371 Date: May 31, 2011

(30) Foreign Application Priority Data
Aug. 18, 2008 (AU) 2008904246

(51) Int. Cl. A47J 37/04; A23L 1/31; A23P 1/00

(52) U.S. Cl. 426/518; 99/419; 426/665

(57) ABSTRACT

A food preparation device including: a body defining a passage; and a mount or head portion for holding a skewer within the passage. The passage has an opening for receiving portions of food such that when a skewer is held by the mount, portions of food entering the opening become impaled on the skewer within the passage. The device is provided with a cutter to cut portions of food such as meat for use in the device.

### FIELD OF THE INVENTION

The present invention relates to a food preparation device. In one arrangement there is provided a kebab maker for use in preparing kebabs for cooking.

### BACKGROUND TO THE INVENTION

Cooking food on skewers is commonly performed in several countries. Vegetables, meat and/or fish are cut into portions and pierced with a skewer and then cooked on a barbecue or in an oven. Food presented in this way is often referred to as a kebab, or a shish kebab.

The skewered portions of food are commonly coated with seasoning and are cut into either large or small pieces depending on the circumstances. Whilst the portions of food are being cooked it is common to turn the skewer so as to evenly distribute cooking oils and ensure that the food is exposed to an even application of heat.

It can be difficult to prepare kebabs so that the pieces of meat or vegetables forming the kebab are of even size and of a neat arrangement when placed on the skewer. The pieces of food can easily drop off the skewer before they are ready for cooking.

It is against this background that the present invention has been developed, in particular in view of the difficulties associated with preparing and cooking kebabs.

References to prior art documents in this specification are provided for illustrative purposes only and are not to be taken as an admission that such prior art is part of the common general knowledge in Australia or elsewhere.

### SUMMARY OF THE INVENTION

According to one aspect of preferred arrangements described herein there is provided a food preparation device comprising: a body defining a passage; and a mount for holding a skewer within the passage; the passage having an opening for receiving portions of food such that when a skewer is held by the mount, portions of food entering the opening become impaled on the skewer within the passage.

Preferably the food preparation device includes a cutter at the opening for cutting the portions of food as the portions pass through the opening.

Preferably the food preparation device includes a head portion wherein the head portion includes the mount. Preferably the head portion is selectively removable from the body at an end spaced away from the opening to allow the skewer to be removed from the passage with the portions of food thereon.

Preferably the head portion is separable into a plurality of elements when removed from the body portion to allow the skewer to be removed from the device. Preferably the head portion comprises two portions arranged to be firmly held in an end of the passage spaced apart from the opening.

Preferably the head portion includes an area in which the skewer is received when mounted by the mount, to protect the hand of the user when pushing down on the head portion. This is considered to advantageously protect the hand of a user when loading the skewer with portions of foodstuffs.

Preferably the mount comprises a first element and a second element for bearing against first and second portions of the skewer. Preferably the first and second elements comprise abutments and first and second, portions of the skewer comprise flange portions.

The skewer may be similar to skewers disclosed in WO 2008/014539 entitled “Food Rack” to the present inventor. The entire teaching of WO 2008/014539 is hereby incorporated by reference for all purposes.

According to a second aspect of preferred arrangements described herein there is provided a method of food preparation comprising mounting a skewer in a manner in which the skewer extends through a passage, the passage having an opening; and thereafter forcing portions of food though the opening such that the portions of food become impaled on the skewer and are held within the passage.

According to a third aspect of preferred arrangements described herein there is provided a kebab preparation device comprising: a mount for locating a skewer; a cutter located at an opening of the passage such that when a skewer is mounted by the mount, portions of food on passing through the opening are cut by the cutter and thereafter become impaled on the skewer.

Preferably the device includes a body defining a passage and the mount is for locating the skewer within the passage.

Preferably the mount is selectively removable from an end of the passage to allow portions of food impaled on the skewer to be removed from the passage. Preferably the mount is adapted to selectively secure the skewer to allow the skewer to be removed from the mount.

According to a fourth aspect of preferred arrangements described herein there is provided a method of preparing food on a skewer comprising: mounting a skewer such that the skewer extends within a passage defined by a body; providing a cutter at an end of the passage; providing a head portion forming part of the body at an opposite end of the body; pushing the head portion downwardly to cause the cutter to cut a portion of foodstuff; and repeating the process to cut further portions of food stuff to force the previously cut portions of food stuff to become impaled further along the skewer.

Preferably the method includes removing the skewer from a mount and thereafter cooking the skewer and portions of foodstuff thereon.

Preferred arrangements of the present invention are considered to provide for the ready preparation of kebabs for cooking in automated rotisseries and the like. Preparing a large number of kebabs is generally time consuming and can be a strenuous exercise. The present invention is considered to be advantageous in this and several other respects.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of several specific embodiments of the invention, given by way of example only, with reference to the accompanying drawings, in which:

FIG. 1 comprises a perspective view of a food preparation device according to a first preferred embodiment of the present invention;

FIG. 2 comprises an exploded perspective view of the food preparation device shown in FIG. 1;

FIGS. 3a, 3b and 3c comprise three partial perspective views illustrating a method according to a second preferred embodiment of the present invention;

FIGS. 4a and 4b comprise two partial perspective views further illustrating the method shown in FIG. 3;

FIG. 5 comprises two further partial perspective views further illustrating the method shown in FIG. 3;

FIGS. 6a and 6b comprise sectional views of a food preparation device according to a third preferred embodiment of the invention;

FIG. 6c comprises a sectional view of the cap of the device of FIGS. 6a and 6b;

FIG. 7 comprises a perspective view of a cooking device for use in the method shown in FIG. 3; and

FIGS. 8a, 8b and 8c comprise several views of a food preparation device according to a fourth preferred embodiment of the present invention.

### DESCRIPTION OF THE PREFERRED EMBODIMENTS

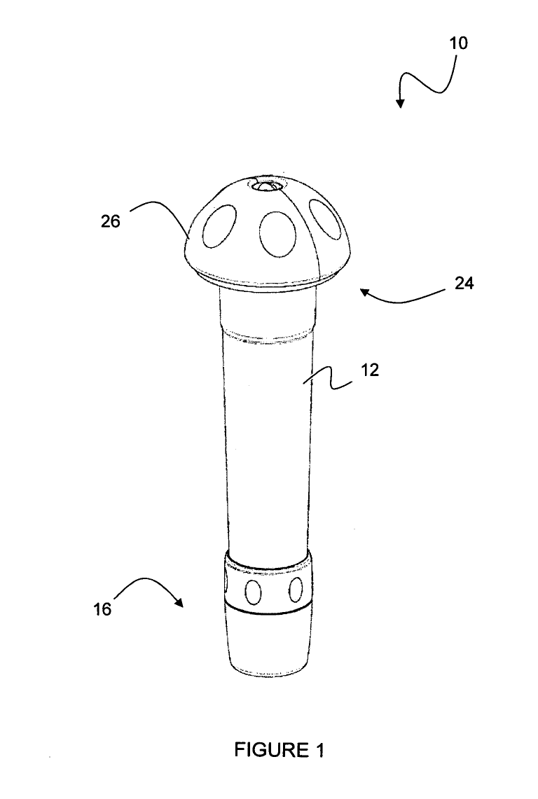

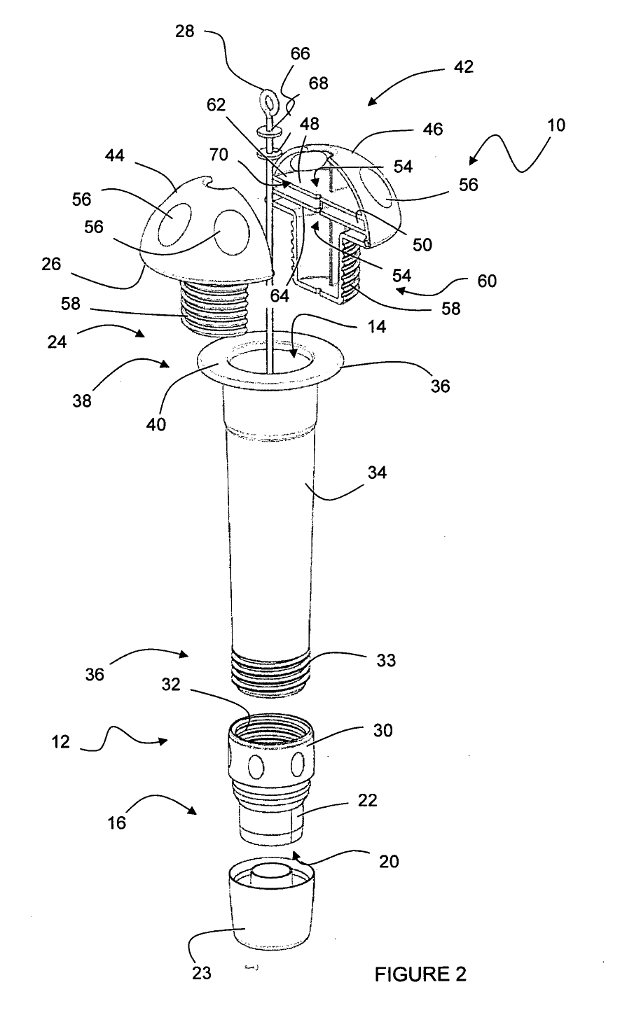

Referring to FIGS. 1 and 2 there is shown a food preparation device 10 according to a first preferred embodiment of the present invention.

Advantageously the food preparation device 10 is able to be used to prepare a number of kebabs that are consistent in size. Moreover the kebabs are provided in a relatively fast and convenient manner. This is in direct comparison to cutting and skewering piece one at a time, which can be labour intensive.

As shown in FIGS. 1 and 2, the food preparation device 10 comprises a body 12 defining a passage 14. At a first end 16 of the device 10 there is provided an opening 20 and a cutter 22 having a cap 23. At an opposite end 24 of the device 10 there is provided a mount arrangement 26 for holding a skewer 28 within the passage 14. As described in further detail below, this allows for the skewer 28 to be held by the mount arrangement 26 whilst portions of food entering the opening 20 are cut and become impaled on the skewer 28.

In use, as further portions of food become impaled they force previously impaled portions of food further along the passage 14. Once fully laden the skewer 28 can then be removed from the passage 14 and cooked. Advantageously, the passage is only able to hold a certain quantity of foodstuff and thus the kebab provided is of a relatively standard size.

In the arrangement, the cutter 22 comprises a stainless steel blade moulded to a plastics member 30. The plastics member 30 has a threaded portion 32 allowing the cutter 22 to be removed for cleaning. A main tubular portion 34 of the body 12 includes a corresponding threaded portion 33 at a first end 36 of the tubular portion 34. This allows the cutter 22 to be securely fastened.

At an opposite end 38, the main tubular portion 34 includes a flange portion 36 extending outwardly in a radial direction. The flange portion 36 provides an abutment 40 for the mount arrangement 26. The mount arrangement 26 is provided as part of a head portion 42 of the device 10.

The head portion 42 comprises a first member 44, a second member 46 forming two halves of the head portion 42. Together the first and second members 44 and 46 provide a first platform element 48, and a second platform element 50. The platform elements 48 and 50 include two sub-platforms, one in each of the halves 44 and 46. Each of the sub-platforms of the platform elements 48 and 50 include an inset portion 54. When the first and second members 44 and 46 are brought together, the insert portions 54 provide two openings for holding the skewer 28.

With the present arrangement the two halves 44 and 46 are identical. This is considered to assist with manufacturing processes and tooling. Furthermore the two halves 44 and 46 include recesses 56 to assist with washing of the device 10 after use.

When the halves 44 and 46 are brought together they form a domed head that is able to be comfortably pushed using one hand. The domed head is selectively removable from the end of the passage by virtue of portions 58 forming a cylindrical closure in a “cork” type arrangement.

The portions 58 each comprise substantially semi-cylindrical portions that are sized to be firmly received with passage 14 at the end 38 of the tubular portion 34 so as to be removable therefrom. Thus when the two halves 44 and 46 are brought together they form a securing element 60 for selectively mounting the head portion 42 to the body 12 of the device 10.

In the embodiment the platform element 48 provides an abutment 62 that prevents the skewer from travelling further into the passage 14 when mounted. The platform element 50, on the other hand, provides an abutment 64 that prevents the portions of food pushing the skewer 22 upwardly out of the passage 14.

Consequently, on upward movement of the skewer a flange 66 engages abutment 62 and on downward movement of the skewer 28 a flange 68 engages the abutment 64. In this embodiment, the flange 66 is arranged to be disposed above platform 48 and flange 68 is arranged to be disposed below platform 50. In use the skewer 28 is securely held in the inset portions 54 by the cooperation of the flanges 66 and 68 and the platform elements 48 and 50.

As shown in FIG. 2 the head portion 42 includes an area 70 in which the skewer 28 is received when mounted to protect the hand of the user when pushing down on the dome of the head portion 42. In this manner, the skewer 28 is substantially concealed whereby the head of the skewer 28 will not bruise or pierce the user's hand when pushing down on the domed head. This is considered to be advantageous given that with conventional skewers it is often difficult to pierce readily large pieces of meat without the user being subject to either end of the skewer. The device 10 is considered to be advantageous for this, and other reasons, that have been described or otherwise would be clearly apparent.

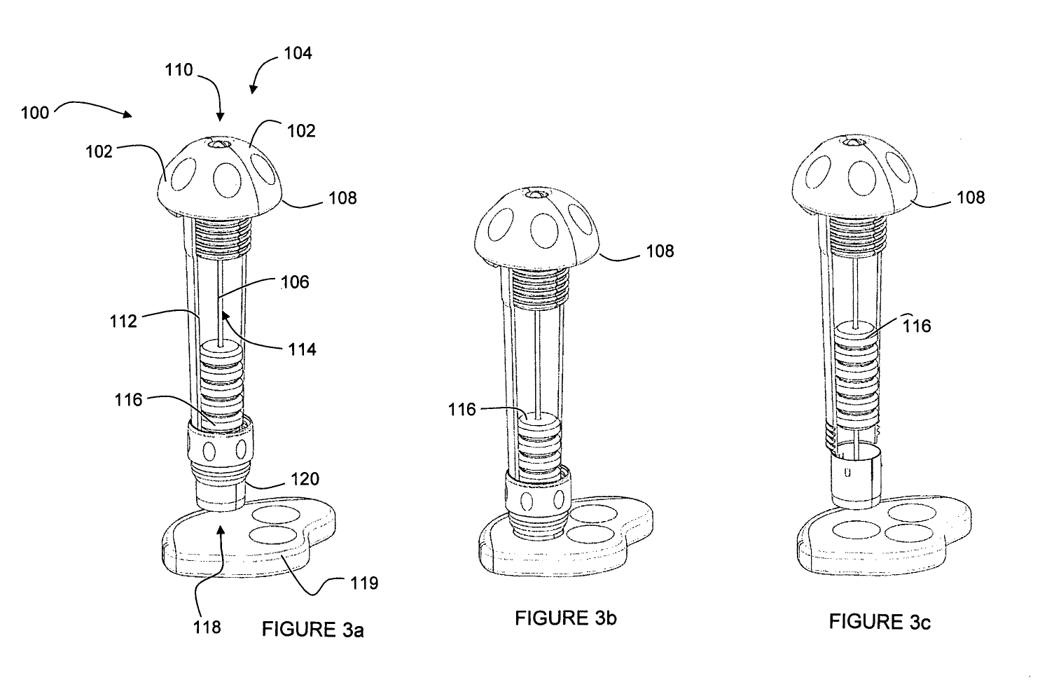

Referring to FIG. 3 there is shown a method of food preparation 100 according to a second preferred embodiment of the present invention. At a first block in the method two halves 102 of a head portion 104 are brought together to secure a skewer 106 therein. As shown in the figures, the head of the skewer 106 is disposed below a curved dome portion 108 of the head portion 104 in a recess 110.

In the method 100, the head portion 104 is subsequently coupled to a body 112 such that the skewer 106 is mounted in a manner in which the skewer 106 extends through a passage 114 of the body 112.

Thereafter the method 100 comprises cutting and forcing portions of food 116 though an opening 118 of the passage 114 whereby the portions of food become impaled on the skewer 106 and are held within the passage 114.

As shown in FIGS. 3a, 3b and 3c, several portions of food are cut by a cutter 120 with the curved dome portion 108 being pushed downwardly to force the cutter 120 through the foodstuff in the form of a piece of meat 119 to cut portions thereof. Whilst the foodstuff is shown as meat 119 in the Figures, other firm foodstuffs such as pasty dough may also be used in the invention.

In the method 100, the process is repeated several times until portions of foodstuff have substantially filled the space within the passageway 114.

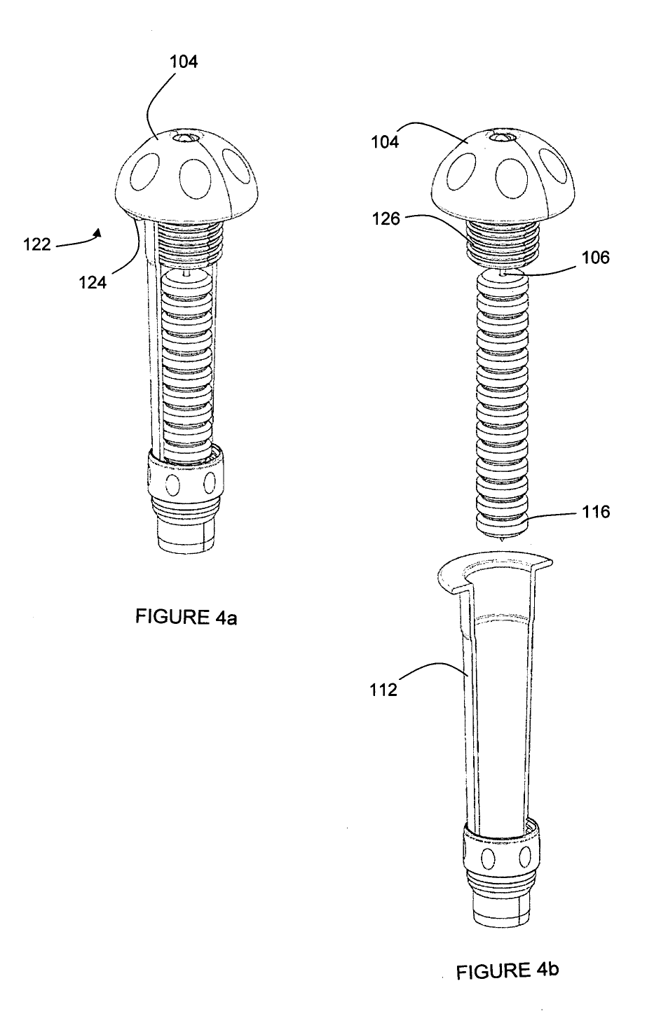

When the cutter cuts a further portion 116 of foodstuff, as the portion is being cut, the portion pushes up the portions of foodstuff previously cut and impaled on the skewer 106. The process of cutting several portions of foodstuff 116 is repeated, until a fully loaded condition is reached as can be seen in FIGS. 4a and 4b.

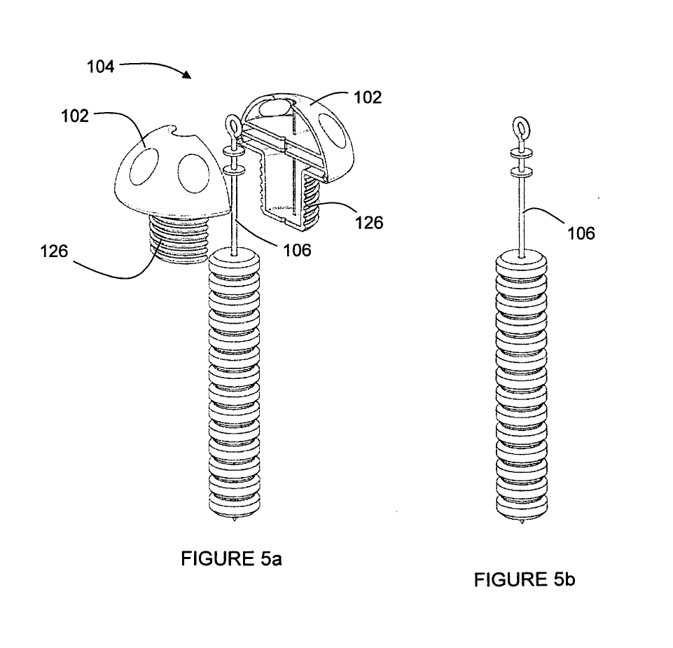

From the loaded condition shown in FIGS. 4 and 5 the head portion 104 is pulled upwardly and separated from the body 112. To assist in this process there is provide a step 122 formed by the head portion 104 being slightly larger in diameter than a lower abutment 124. This allows a user to advantageously hook their fingers over the head portion 104 and pull the head portion 104 whilst gripping the device,

By this action, end portions 126 of halves 102 the head portion 104 are released from the passageway 114. This allows the two halves 102 to be separated, consequently releasing the skewer 106 from the clamp type arrangement with the portions 116 of foodstuff thereon. This advantageously provides a skewer of a size corresponding to a standard length defined by the passageway 114. The passage 114 is transparent and includes markings showing the length of the kebab being produced.

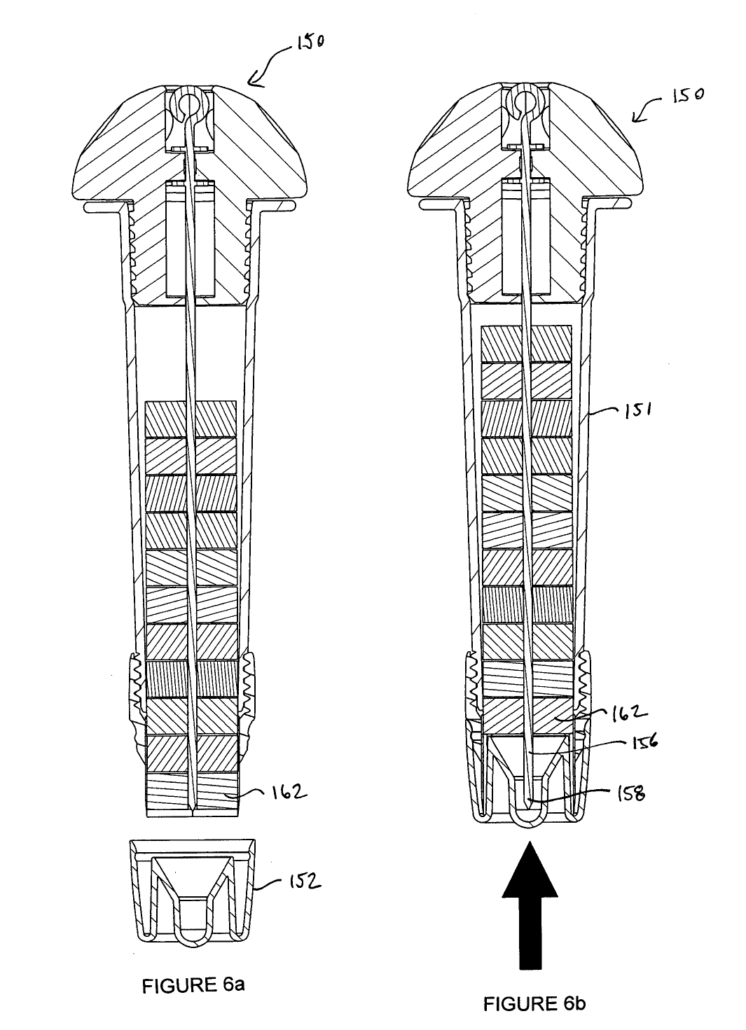

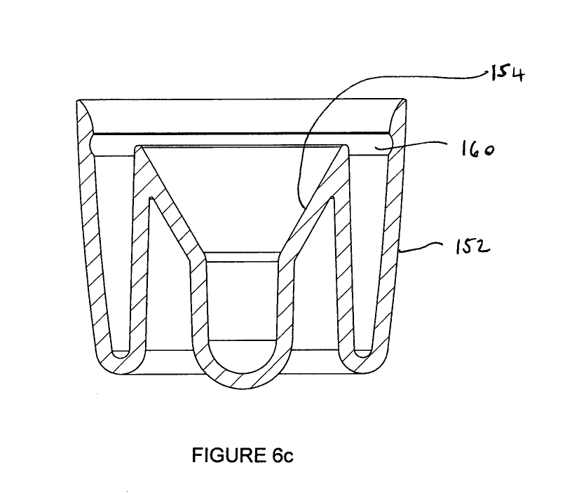

FIG. 6 shows a third embodiment of the invention of a food preparation device 150 with cap 152. The device 150 resembles the device of the first embodiment as shown in FIGS. 1 and 2 in many ways except for the end cap 152. As can be seen in FIGS. 6a, 6b and 6c, cap 152 has a tapered cavity 154 in which the end 158 of the skewer 156 is housed when the cap 152 is placed on the lower end of the body 151 of the device 150. As can best be seen in FIGS. 6b and 6c, the cap 152 also comprises an internal abutment portion 160 around the inner rim of the cap. When the cap is placed on the end of the body 151, the abutment portion 160 pushes against the lowest piece of meat 162 forcing the row of meat pieces up into the passage in the body 151. As can also be seen in FIG. 6b, the internal cavity 153 of the body 151 is tapered to increasing diameter at the upper end of the housing to allow for ease of withdrawal of the skewer with meat pieces to be withdrawn from the cavity.

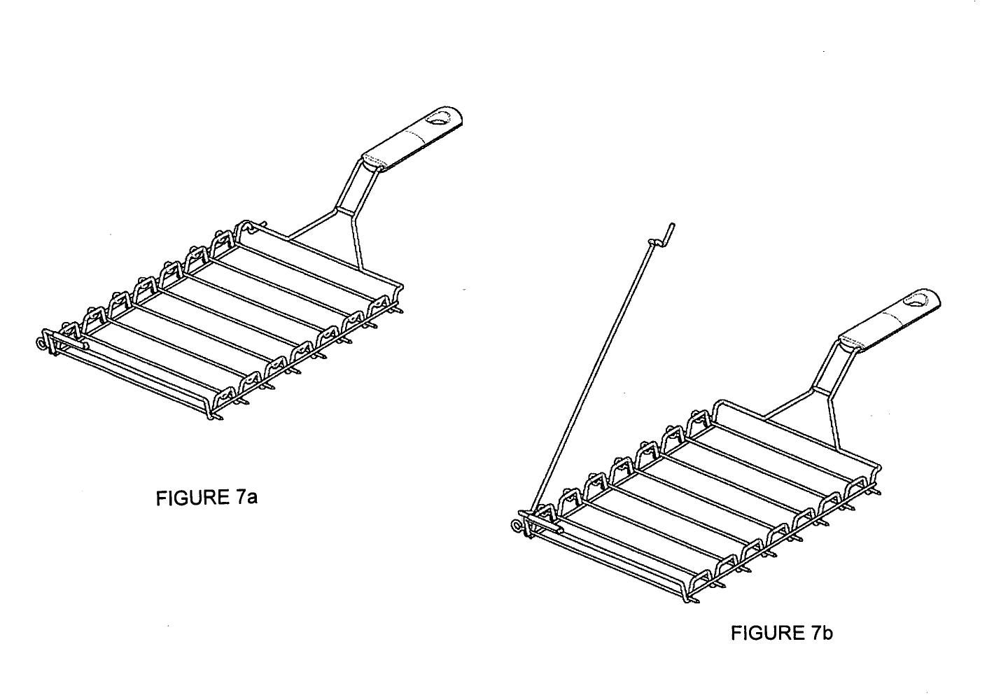

In the method 100 several skewers are prepared and cooked in a cooking device 128 shown in FIG. 7. This cooking device is disclosed in WO 2008/014539 the entire teaching of which is hereby fully incorporated by reference for all purposes.

The method 100 is considered to relatively rapidly result in the preparation of kebabs of a standard length suitable for cooking in the cooking device shown in FIG. 6. This is considered particularly advantageous in situations in which one or two people have to prepare a relatively large number of kebabs.

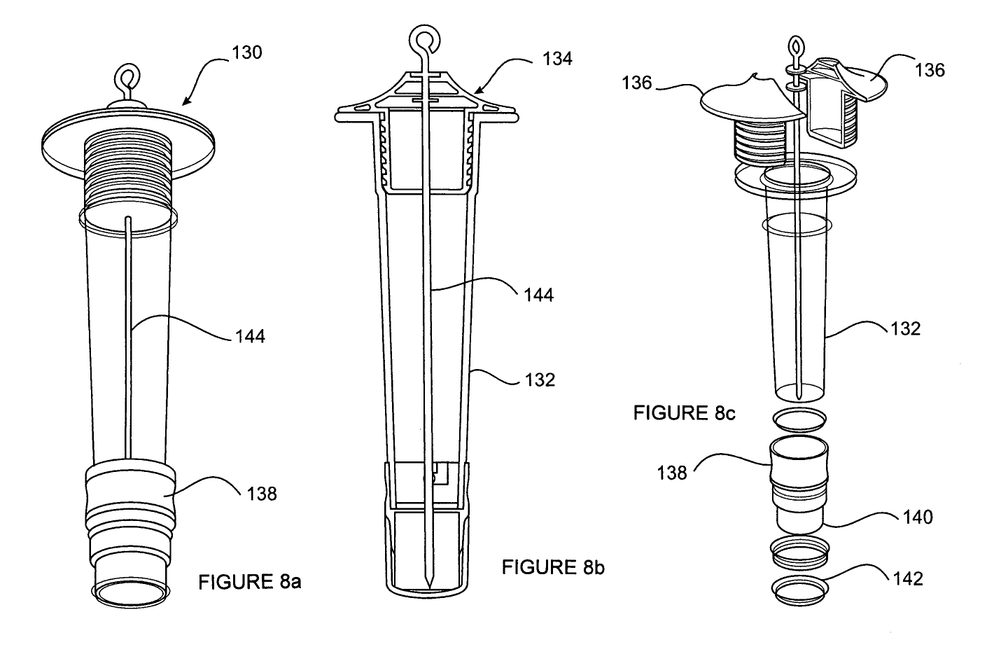

A further preferred embodiment of a food preparation device 130 of the present invention is shown in FIG. 8 (which is used in the same way as described for the other embodiments of the invention). Advantageously the device 130 uses a bayonet arrangement 138 to couple a cutting element 140 to a main tubular body 132. A skewer 144 is placed within the tubular body 132. A cap 142 is provided to cover the cutting element or blade 140. The mount arrangement 134 of the device 130 of FIG. 8 comprises two identical halves 136 which have an increased tapered upper surface (as compared to the embodiments shown in FIGS. 1 to 6) which allows for ease of pressing downwardly on the upper surface of the mount 134 to force the cutter through the meat during use of the device of the invention. The device may be readily moulded since it consists of three moulded parts; the identical halves of the mount, the tubular body and the bayonet fitting over the blade or cutter.

Having now described several preferred embodiments of the invention, it will be apparent that preferred embodiments provide for a number of advantages including:
1) The ability to readily cut foodstuffs including meat, fish and vegetables into portions.
2) The ability to cut portions of foodstuffs into regular sized pieces constituently and accurately for being pierced and held on a skewer.
3) The ability to consistently and relatively rapidly provide kebabs of proportions that are suitable for use in automated cooking arrangements; and
4) The ability to make kebabs without suffering the common problem of the base of the skewer piercing or substantially bruising the soft tissue of the user's hands.

It will be readily apparent to persons skilled in the relevant arts that various modifications and improvements may be made to the foregoing embodiments, in addition to those already described, without departing from the basic inventive concepts of the present invention. Therefore, it will be appreciated that the scope of the invention is not limited to the specific embodiments described.

1. A food preparation device comprising:
a body defining a passage; and
a mount for holding a skewer within the passage;
the passage having an opening for receiving portions of food to be impaled on the skewer held by the mount, wherein the portions of the food entering the opening become impaled on the skewer within the passage.

2. A food preparation device as defined in claim 1, further comprising a cutter at the opening for cutting the portions of the food as the portions pass through the opening.

3. A food preparation device as defined in claim 1, further comprising a head portion, the head portion including the mount.

4. A food preparation device as defined in claim 3, wherein the head portion is selectively removable from the body at an end spaced away from the opening to allow the skewer to be removed from the passage with the portions of food thereon.

5. A food preparation device as defined in claim 3, wherein the head portion is separable into a plurality of elements when removed from the body portion to allow the skewer to be removed from the device.

6. A food preparation device as defined in claim 5, wherein the head portion comprises two portions arranged to be firmly held in an end of the passage spaced apart from the opening.

7. A food preparation device as defined in claim 3, wherein the head portion includes an area in which the skewer is received when mounted by the mount, to protect the hand of the user when pushing down on the head portion.

8. A food preparation device as defined in claim 1, wherein the mount comprises a first element and a second element for bearing against first and second portions of the skewer.

9. A food preparation device as defined in claim 8, wherein the first and second elements comprise abutments, and first and second portions of the skewer comprise flange portions.

10. A method of food preparation comprising:
mounting a skewer to extend through a passage, the passage having an opening; and
thereafter forcing portions of food though the opening such that the portions of food become impaled on the skewer and are held within the passage.

11. A kebab preparation device comprising:
a mount for locating a skewer;
a cutter located at an opening of the passage such that, when a skewer is mounted by the mount, portions of food on passing through the opening are cut by the cutter and thereafter become impaled on the skewer.

12. A kebab preparation device as defined in claim 11, wherein the device includes a body defining a passage and the mount locates the skewer within the passage.

13. A kebab preparation device as defined in claim 12, wherein the mount is selectively removable from an end of the passage to allow portions of food impaled on the skewer to be removed from the passage.

14. A kebab preparation device as defined in claim 11, wherein the mount is adapted to selectively secure the skewer to allow the skewer to be removed from the mount.

15. A method of preparing food on a skewer comprising:
mounting a skewer to extend within a passage defined by a body; providing a cutter at an end of the passage;
providing a head portion forming part of the body at an opposite end of the body;
pushing the head portion downwardly to cause the cutter to cut a portion of foodstuff; and
repeating the process to cut further portions of food stuff to force the previously cut portions of food stuff to become impaled further along the skewer.

16.-19. (canceled)

20. A device to assist impaling food on a skewer, the device comprising:
a hollow body having a passage within the body and an opening to the passage at a distal end of the body, wherein the passage is tapered and expands from the distal end to a proximal end of the body;
a mount releasably holding a skewer within and coaxial to the passage, wherein the mount is releasably attached to the proximal end of the body, and
a food cutting edge aligned with the opening and at the distal end of the passage.

21. The device of claim 21 further comprising a cap to be placed on the distal end of the body, wherein the cap includes an abutment having an abutment surface adapted to protrude into the opening and a cavity in the abutment surface receives the tip of the skewer when the cap is on the distal end of the body.
